(19) United States
(12) Patent Application Publication
(10) Pub. No.: US 2019/0306192 A1
(43) Pub. Date: Oct. 3, 2019

(54) DETECTING EMAIL SENDER IMPERSONATION

(71) Applicant: Fortinet, Inc., Sunnyvale, CA (US)

(72) Inventors: Michael Xie, Palo Alto, CA (US); Jiandong Cheng, Ottawa (CA); J. Brian MacGillivray, Kemptville (CA)

(73) Assignee: Fortinet, Inc., Sunnyvale, CA (US)

(21) Appl. No.: 15/938,659

(22) Filed: Mar. 28, 2018

(51) Int. Cl. H04L 29/06; H04L 12/58

(52) U.S. Cl. CPC H04L 63/1483; H04L 63/1466; H04L 63/0272; H04L 51/12; H04L 69/22; H04L 63/1425

(57) ABSTRACT

Systems and methods for detecting email messages in which the sender is attempting to impersonate an email user of the target domain are provided. According to one embodiment, an email is received by a network security device protecting a private network. A value of at least one header field of the received email is parsed to extract a display name and an email address. A determination is made regarding whether the received email is associated with an external domain. When it is determined that the received email is associated with an external domain, then a further determination is made regarding whether the received email potentially involves sender impersonation based on a comparison of the display name with display names associated with users of the private network meeting a predetermined or configurable similarity threshold.

### COPYRIGHT NOTICE

Contained herein is material that is subject to copyright protection. The copyright owner has no objection to the facsimile reproduction of the patent disclosure by any person as it appears in the Patent and Trademark Office patent files or records, but otherwise reserves all rights to the copyright whatsoever. Copyright © 2018, Fortinet, Inc.

### BACKGROUND

### Field

Embodiments of the present invention generally relate to the field of network security. In particular, embodiments of the present invention relate to electronic mail (email) security for detecting spoofed emails that are fraudulently or maliciously sent to a user.

### Description of the Related Art

Electronic mail (Email) spoofing typically involves creation of an email message with a forged value of one or more headers of the email message. When a spoofed email is sent, generally the sender's name, address and/or body of the email message are configured so as to appear that it is sent from a trustworthy source (e.g., a friend, colleague or superior). For example, spammers or malicious senders may send email messages with a forged “From” or “Reply-To” header. These headers include two parts—a display name portion and an email address portion. Malicious senders may forge the email address portion of the “From” header to make it appear that the email message was sent from any domain they wish. In many occasions, spoofed emails are used to dishonestly market an online service, sell a bogus product or divert or impede billing or financial transactions. For instance, a malicious sender can send a spoofed email to an accountant, pretending to be the Chief Financial Officer (CFO) of a company, and ask the accountant to transfer funds to an account.

While many techniques have been developed to prevent a user from becoming a victim of email address spoofing, including technologies, such as Sender Policy Framework (SPF), Domain Keys Identified Mail (DKIM), Domain-based Message Authentication, Reporting and Conformance (DMARC), these techniques do not preclude a more simplistic form of email spoofing in which the sender simply forges the display name portion of the “From” header of the email message. This approach is effective as many email clients do not present all of the email headers to the recipient of an email message by default when viewed by the recipient and typically require the recipient to perform additional steps (e.g., view full headers). For example, some email clients simply present the display name portion of the “From” header of an email message without the email address portion of the “From” header. In such a scenario, a fraudulent sender using a trustworthy display name with which the recipient is familiar in an attempt to fool the recipient is likely to be successful as the recipient may simply trust the forged display name presented to him/her.

In view of the foregoing, there is a need for an anti-email spoofing technique that scrutinizes display names of email messages received from external domains.

### SUMMARY

Systems and methods are described for detecting email messages in which the sender is attempting to impersonate an email user of the target domain. According to one embodiment, an email is received by a network security device protecting a private network. A value of at least one header field of the received email is parsed to extract a display name and an email address. A determination is made regarding whether the received email is associated with an external domain. When it is determined that the received email is associated with an external domain, then a further determination is made regarding whether the received email potentially involves sender impersonation based on a comparison of the display name with display names associated with users of the private network meeting a predetermined or configurable similarity threshold.

Other features of embodiments of the present invention will be apparent from accompanying drawings and from detailed description that follows.

### BRIEF DESCRIPTION OF THE DRAWINGS

In the figures, similar components and/or features may have the same reference label. Further, various components of the same type may be distinguished by following the reference label with a second label that distinguishes among the similar components. If only the first reference label is used in the specification, the description is applicable to any one of the similar components having the same first reference label irrespective of the second reference label.

FIG. 1 is a block diagram illustrating a simplified network architecture in which or with which embodiments of the present invention can be implemented.

FIG. 2 is a module diagram illustrating functional units of a secure email gateway in accordance with an embodiment of the present invention.

FIG. 3 is a block diagram conceptually illustrating the processing of an email message in accordance with an embodiment of the present invention.

FIGS. 4A-C show various ways email clients may present a received email message to the recipient.

FIGS. 5A-5B depict portions of a “From” header of an email message.

FIG. 6A is a flow diagram illustrating email sender impersonation detection processing in accordance with an embodiment of the present invention.

FIG. 6B is a flow diagram illustrating display name match processing in accordance with an embodiment of the present invention.

FIG. 7 illustrates an exemplary computer system in which or with which embodiments of the present invention may be utilized in accordance with embodiments of the present disclosure.

### DETAILED DESCRIPTION

In the following description, numerous specific details are set forth in order to provide a thorough understanding of embodiments of the present invention. It will be apparent to one skilled in the art that embodiments of the present invention may be practiced without some of these specific details.

Embodiments of the present invention include various steps, which will be described below. The steps may be performed by hardware components or may be embodied in machine-executable instructions, which may be used to cause a general-purpose or special-purpose processor programmed with the instructions to perform the steps. Alternatively, steps may be performed by a combination of hardware, software, firmware and/or by human operators.

Embodiments of the present invention may be provided as a computer program product, which may include a machine-readable storage medium tangibly embodying thereon instructions, which may be used to program a computer (or other electronic devices) to perform a process. The machine-readable medium may include, but is not limited to, fixed (hard) drives, magnetic tape, floppy diskettes, optical disks, compact disc read-only memories (CD-ROMs), and magneto-optical disks, semiconductor memories, such as ROMs, PROMs, random access memories (RAMs), programmable read-only memories (PROMs), erasable PROMs (EPROMs), electrically erasable PROMs (EEPROMs), flash memory, magnetic or optical cards, or other type of media/machine-readable medium suitable for storing electronic instructions (e.g., computer programming code, such as software or firmware).

Various methods described herein may be practiced by combining one or more machine-readable storage media containing the code according to the present invention with appropriate standard computer hardware to execute the code contained therein. An apparatus for practicing various embodiments of the present invention may involve one or more computers (or one or more processors within a single computer) and storage systems containing or having network access to computer program(s) coded in accordance with various methods described herein, and the method steps of the invention could be accomplished by modules, routines, subroutines, or subparts of a computer program product.

If the specification states a component or feature “may”, “can”, “could”, or “might” be included or have a characteristic, that particular component or feature is not required to be included or have the characteristic.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all groups used in the appended claims.

Exemplary embodiments will now be described more fully hereinafter with reference to the accompanying drawings, in which exemplary embodiments are shown. This invention may, however, be embodied in many different forms and should not be construed as limited to the embodiments set forth herein. These embodiments are provided so that this disclosure will be thorough and complete and will fully convey the scope of the invention to those of ordinary skill in the art. Moreover, all statements herein reciting embodiments of the invention, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

While embodiments of the present invention have been illustrated and described, it will be clear that the invention is not limited to these embodiments only. Numerous modifications, changes, variations, substitutions, and equivalents will be apparent to those skilled in the art, without departing from the spirit and scope of the invention, as described in the claim.

Systems and methods described herein relate to detection of email messages in which the sender of the email is attempting to impersonate an email user of the target domain. An aspect of the present disclosure pertains to a network security device in the form of a secure email gateway, for example, and which may also be referred to as the system, hereinafter, for protecting a private network, the secure email gateway may include: a non-transitory storage device having embodied therein one or more routines operable to facilitate detection of a spoofed email; and one or more processors coupled to the non-transitory storage device and operable to execute the one or more routines, wherein the one or more routines can include: a parsing module, which when executed by the one or more processors, parses a value of at least one header field of a received email into a display name and an email address; and a spoofed email detection module, which when executed by the one or more processors, determines whether the received email address is associated with an external domain and if so, identifies the received email as potentially involving sender impersonation when a comparison of the display name with multiple display names associated with users of the private network meets a predetermined or configurable similarity threshold.

In an embodiment, the at least one header field can be selected from any or a combination of “From”, “Reply-To”, “Reply to All”, “CC”, and “BCC”.

In an embodiment, the domain associated with the email address can be considered as an external domain when the domain specified in one or more of the “From” and “Reply-To” header fields does not match the internal domain protected by the secure email gateway.

In an embodiment, the comparison of the display name with the display names associated with users of the private network can be performed by matching the display name in an internal display name database, wherein the comparison is performed responsive to determining the domain associated with the email address is an external domain.

In an embodiment, the internal display name database can be generated from any or a combination of processing of inbound email traffic, outbound email traffic, and query or import from one or more email directory servers.

In an embodiment, the email can be determined to be spoofed when (i) the display name is found to be present in the internal display name database and (ii) the domain associated with the email address is an external domain.

In an embodiment, matching of the display name in the internal display name database can be carried after normalization of each special character present in the display name to a defined unique character, and tokenization of the display name into multiple tokens based on the unique character so as to form one or more search strings for search in the internal display name database based on a combination of two or more tokens. In an exemplary embodiment, the unique character can be a whitespace character (e.g., a character tabulation, a line feed, a line tabulation, a form feed, a carriage return, a space, a next line, a no-break space and the like).

Another aspect of the present disclosure pertains to a method that includes: parsing, at a network device that receives an email, a value of at least one header field of the received email into a display name and an email address; determining whether the received email address is associated with an external domain; and when the received email address is determined to be associated with an external domain, then identifying the email as potentially involving sender impersonation when a comparison of the display name with display names associated with users of the private network meets a predetermined or configurable similarity threshold with respect to at least one of the display names of users associated with the private network.

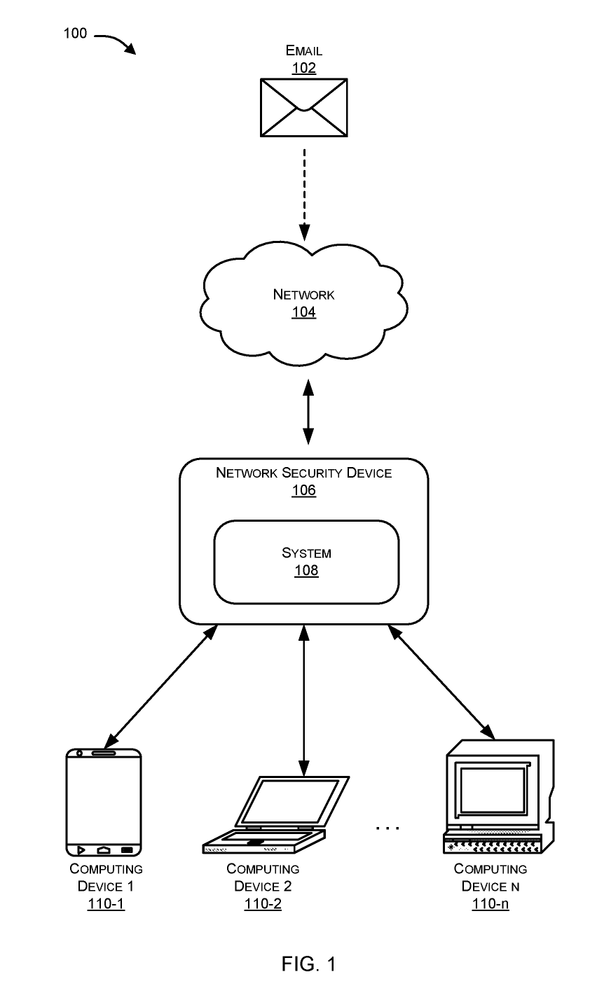

FIG. 1 is a block diagram illustrating a simplified network architecture 100 in which or with which embodiments of the present invention can be implemented. In the context of the present example, a secure email gateway (which may be referred to as system 108, hereinafter) can be implemented using/in a network security device 106 to protect a private network by facilitating detection of a spoofed email. Network architecture 100 contains multiple computing devices 110-1, 110-2, . . . , 110-N (collectively referred to as the computing devices 110 and individually referred to as the computing device 110, hereinafter) that can be communicatively coupled to an external network 104 (e.g., the Internet) via network security device 106 that implements system 108. Network security device 106 can be logically or physically interposed between an internal or a private network and an external network, to protect the private network from malicious actors while allowing computing devices 110 of the private network to access legitimate resources associated with network 104 and to exchange email messages, such as email 102, with users external to the private network.

The private network can pertain to an entity such as an organization, a company, an enterprise, a workplace and the like and can only be accessible to users affiliated with or otherwise associated with the entity through computing devices 110. In one embodiment, users can be employees, staff, workforce or any other person that is associated with the entity. Computing devices 110 can include personal computers, smart devices, web-enabled devices, hand-held devices, laptops, smartphones and the like that can be used by the users to connect to the private network.

As those skilled in the art will appreciate, various networks described herein can include, but are not limited to, wireless networks, wired networks or a combination thereof that can be implemented as one of the different types of networks, such as an Intranet, a Local Area Network (LAN), a Wide Area Network (WAN), Internet, and the like. Further, the networks can serve as a dedicated network or a shared network. A shared network represents an association of different types of networks that use a variety of protocols, for example, Hypertext Transfer Protocol (HTTP), Transmission Control Protocol/Internet Protocol (TCP/IP), Wireless Application Protocol (WAP), and the like.

Further, network security device 106 can provide an interface between the private network and the external network by effectively managing, regulating, filtering and/or scanning network traffic by utilizing a set of protocols. Network security device 106 may represent a firewall, an antivirus scanning device, a content filtering device, an intrusion detection device, a local or cloud-based secure email gateway in virtual or physical form, or a Unified Threat Management (UTM) device. In an exemplary embodiment of the present disclosure, system 108 can be implemented using any or a combination of hardware and software elements and may be coupled to other network devices and services associated with the private network, including, but not limited to routers, bridges, servers, access points, gateways, hubs, email clients and mail servers. Although in various embodiments of the present disclosure system 108 is described as being implemented within network security device 106, those skilled in the art will appreciate that system 108 can also be implemented as a stand alone device or as a module implemented within a mail server or an endpoint security solution.

According to one embodiment of the present disclosure, system 108 can receive an email 102 that is directed to a user of a private network from an external network. Email 102 contains a header including various header fields having information concerning the sender and recipient(s). The header fields can include, but are not limited to, “From”, “To”, “Reply-To”, “Subject”, “Date”, “Reply to All”, “CC” and “BCC”. The header field can include a display name and an email address, however, in various instances, the header field can have an actual value including the display name and the email address, but when the header field is displayed to the recipient, the header field can only indicate display name, thereby hiding the email address. Such instances can present a false notion to the user by presenting a trusted display name and hiding the email address that can indicate an injurious source. Further background and information regarding email header field definitions and usage is provided by Internet Engineering Task Force (IEFT) Request for Comments (RFC) 822 and RFC 2076 both of which are hereby incorporated by reference in their entirety for all purposes.

In an embodiment, system 108 can parse the value of the header field into a display name portion and an email address portion. The email addresses can be available in the header fields in multiple formats such as being enclosed in angle brackets. System 108, by segregating the display name and the email address, can effectively analyze the source of an email to detect a spoofed email. In an example, if user of a private network receives an email from a sender having the display name “Mr. Abc” and the email address “abc@xyz.com”, the header field of the “From” header can have a header value “abc <abc@xyz.com>”. System 108 can segregate the header value into display name “abc” and email address “abc@xyz.com”. Even when an email client only presents the display name to the recipient and hides the email address, system 108 can parse the actual value of the header field containing the display name and the email address. For instance, when an email user of the private network receives an email from a sender with the name “Mr. Abc” and email address “abc@xyz.com”, depending upon the particular email client employed by the recipient, only the display name portion (i.e., “abc”) of the header field of the “From” header may be presented to the user, while the “From” header may have an actual header value of “abc <abc@xyz.com>” that can be parsed into multiple portions, including a display name “abc” and an email address “abc@xyz.com”.

Further, system 108 can determine whether the received email is from an email address that is associated with an external domain by analyzing the email address extracted from the “From” header, for example. The domain associated with the email address can be considered/identified/detected as an external domain when the domain is not the target domain. For example, the domain portion of the “Reply-To” or “From” header field of the received email is different from that of the domain associated with the private network being protected by system 108. For purposes of clarity, an entity LMN can own a domain name “LMN.com” that can be used by users of the entity LMN for email services. When a user of the entity LMN receives an email associated with any domain other than “LMN.com”, it can be considered as an email associated with an external domain.

Furthermore, in an event when the email address is associated with an external domain, system 108 can compare the display name of the header field with display names that are associated with the users of the private network in order to identify whether email 102 potentially involves sender impersonation. As display names are commonly a user's nickname, a combination of one or more of a user's first, middle and/or last name or portions thereof and users are typically familiar with other users within the enterprise or at least within their particular department, for example, an attacker may attempt to spoof the display name of the email to make it appear to be from a trustworthy source, e.g., someone the recipient knows, by inserting a display name of a user of the target domain into the display name portion of an email header field. As such, in one embodiment, of the present invention, this type of email sender impersonation is attempted to be identified by comparing the display name of the header value of the received email with display names associated with real users associated with the private network and contained in an internal display name database, for example.

In an embodiment, email 102 can be identified as potentially involving sender impersonation when the comparison of the display name associated with the received email with the internal (trusted) display names meets a predetermined or configurable similarity threshold. The similarity threshold can represent an upper or lower limit, depending upon the approximate matching algorithm employed, for similarity between the display name of the header field and a display name that is part of the set of internal display names. Thus, if a resemblance level or closeness of a match output by an approximate string matching algorithm or fuzzy string searching algorithm, for example, exceeds or falls below the similarity threshold, as the case may be, the email can be identified as one involving sender impersonation. For example, if the similarity threshold is expressed in terms of the Levernshtein distance, which measures the number of edits or substitutions required to transform one string into another, then a similarity threshold of 2 would require the Levernshtein distance between the display name of the received email and a display name in the set of internal display names to be 2 or less to be considered an attempted impersonation. Those skilled in the art will appreciate various other approximate string matching algorithms and thresholds may be used. For example, other popular measures of edit distance between two given strings include, Damerau-Levenshtein distance, the longest common subsequence (LCS), the Hamming distance and the Jaro distance.

Those skilled in the art will appreciate that using the similarity threshold, identifying the existence of a display name within a received email having a significant resemblance to a display name of a user of the target domain at issue can be used to detect a spoofed email. For example, if a display name “Jhondoe” is not a part of the internal set of display names, but “Jhndo” is one of the internal display names, system 108 can identify the display name as potentially indicative of email sender impersonation. Thus, embodiments of the present disclosure aid in defending against emails involving sender impersonation so that such potentially malicious emails can either be blocked, quarantined and/or alerted to a network administrator or if they are delivered, they can be clearly marked in the subject line, for example, to alert the recipient of the possibility of sender impersonation.

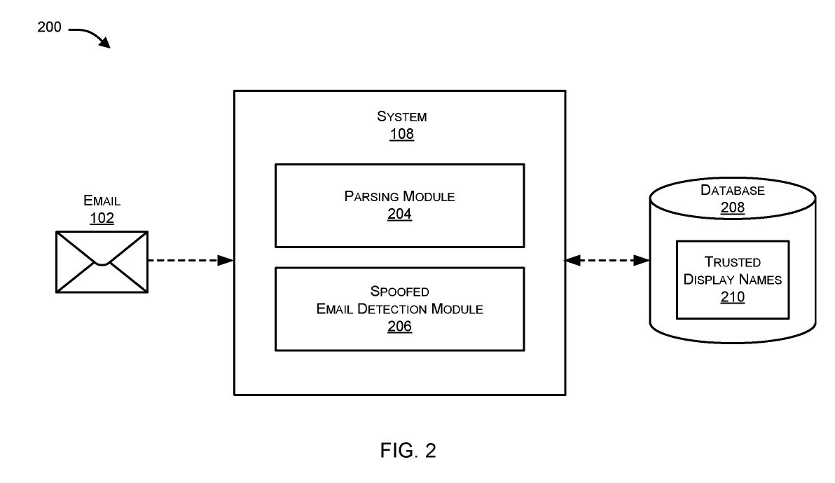

FIG. 2 is a module diagram 200 illustrating functional units of a secure email gateway 108 in accordance with an embodiment of the present invention. In the context of the present example, the secure email gateway (e.g., system 108) can include a parsing module 204 and a spoofed email detection module 206. In an embodiment, system 108 can receive an email 102 directed to a user of a private network from an external network. The private network can pertain to an entity such as a company, an organization, a workplace or the like. Email 102 can have a header that can contain information concerning a sender and recipient(s) and a body that can contain the actual content directed from the sender to the recipient(s). The header can contain, among other things, various header fields such as “From”, “To”, “Reply-To”, “Date”, “Subject”, “Reply to All”, “CC”, “BCC”. For example, if email 102 is directed from a sender “abc@xyz.com” to a recipient “qwe@rty.com”. Various header fields of email 102 may be as follows:
From: Abc<abc@xyz.com>
Subject: Information
Date: January 3, 2018 1:20:58 PM PDT
To: qwe@rty.com

In some instances, the header field can have an actual value including the display name and the email address, however, when the header field information is displayed to the recipient by the recipient's email client, only the display name may be presented, thereby effectively hiding the email address. For example, if email 102 is directed from a sender “abc@xyz.com” to a receiver “qwe@rty.com”, the actual header value of the “From” header can be “Abc <abc@xyz.com>”, however, the recipient may only be presented with “Abc” in the “From” line assembled by their particular email client. Such instances increase the probability of the recipient failing to recognize the actual source of the email, which can result in the recipient becoming a victim of an email impersonation attack.

In an embodiment, in order to facilitate detection of a spoofed email, parsing module 204 of system 108 can parse the value of the header field into a display name and an email address. Those skilled in the art appreciate that the email addresses can be available in various of the email header fields in multiple formats. In an instance, the email address can be enclosed in angle brackets. For example, if a user of the private network receives an email from a sender with a display name of “abc” and an email address of “abc@xyz.com”, the “From” header can have a header value of “abc<abc@xyz.com>”. Parsing module 204 can extract both the display name and the email address from the value of the header field of email 102 by parsing the header value into display name “abc” and email address “abc@xyz.com”. Thus, when the user of the private network receives an email from the sender with name “abc” and email address “abc@xyz.com”, despite the user's email client potentially displaying only the display name “abc” to the user, system 108 will evaluate both the display name and the email address portion of one or more email header fields (e.g., the “From” and/or “Reply-To” headers) by parsing module 204 parsing and segregating the header value into a display name portion (“abc” in the context of the present example) and an email address portion (“abc@xyz.com” in the context of the present example).

In an aspect, the spoofed email detection module 206 can analyze the extracted email address to determine whether the received email is from an email address that is associated with an external domain. The domain associated with the email address is identified as an external domain when it does not match the internal domain protected by system 108. For example, if the domain protected by system 108 is “entitya.com,” then a received email from any domain other than “entitya.com” is considered to be associated with an external domain. Such emails are subject to further scrutiny as described herein; however, an email that is received from an email address within the domain “entitya.com” requires no further checking by spoofed email detection module 206 and is delivered to the intended recipient(s) assuming it successfully passes any additional email scanning that may be performed subsequent to system 108.

When the extracted email address is associated with an external domain, spoofed email detection module 206 compares the extracted display name with internal (trusted) display names associated with users of the private network to determine whether email 102 potentially involves sender impersonation. For example, the comparison may involve matching the extracted display name to display names 210 contained in an internal display name database 208 that includes names of users that would likely be deemed trustworthy by users of the private network. It is pertinent to note that an entity associated with a private network may be a target for attacks by emails involving sender impersonation, which can be designed to steal money, intellectual property or other sensitive data pertaining to the entity. Thus, the present disclosure presents a solution to defend against such emails by detecting potential email sender impersonation so that such malicious emails can be blocked, quarantined, brought to the attention of a network administrator and/or delivered with a warning to the recipient indicating the possibility of sender impersonation.

In an embodiment, flagging or identification of a received email as potentially involving sender impersonation is performed when the comparison of a display name extracted from the received email with trusted display names 210 meets a similarity threshold. In one embodiment, the similarity threshold can be a lower limit for the similarity between the display name of the header field and a display name that is part of trusted display names 210. If a significant resemblance level exceeding the similarity threshold is detected, the email can be identified as one involving sender impersonation. In an embodiment, the similarity threshold can be pre-determined or configurable. The similarity threshold can be predetermined when a value of the similarity threshold is established or set in advance, say a value of similarity threshold can be set to 0.75, which means if the display name has a match in the internal display name database that is 75% or more similar to a trusted display name, then the email can be identified as involving sender impersonation. The similarity threshold can also be configurable, meaning the value of the similarity threshold can be varied. For example, system 108 can allow a user or an administrator to manually set the similarity threshold to a value of 0.8, which means if the display name associated with the received email has a match in the internal display name database that is 80% or more similar to a trusted display name, then the email can be identified as involving sender impersonation.

In an embodiment, the internal display name database 208 can be generated by processing and analyzing display names observed in inbound and/or outbound email traffic. For instance, database 208 can be generated by extracting display names of recipients of emails that are received by the users of the private network or display names of the senders of emails that are sent by the users of the private network to various other recipients. Further, internal display name database 208 can also include display names that can be extracted by querying and/or importing the email addresses or display names from one or more email directory servers associated with the private network at issue. Those skilled in the art appreciate that such email directory servers are typically used to provide services such as authentication, authorization and identity management on behalf of the private network and includes a database used to store user data to provide a centralized directory service. In one embodiment, system 108 can build database 208 based on information acquired from the email directory servers or a database maintained by such email directory servers may represent database 208.

It is pertinent to note that in embodiments of the present invention, the comparison of the extracted display name from a received email with the internal display name database 208 is performed responsive to determining the domain associated with the email address of the received email is an external domain. In such an implementation, only those received emails associated with an external domain have the potential for being identified as involving email sender impersonation.

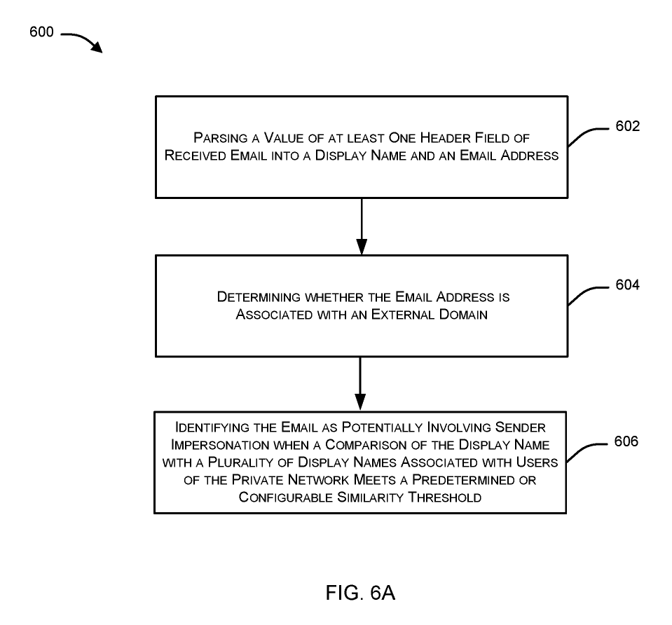

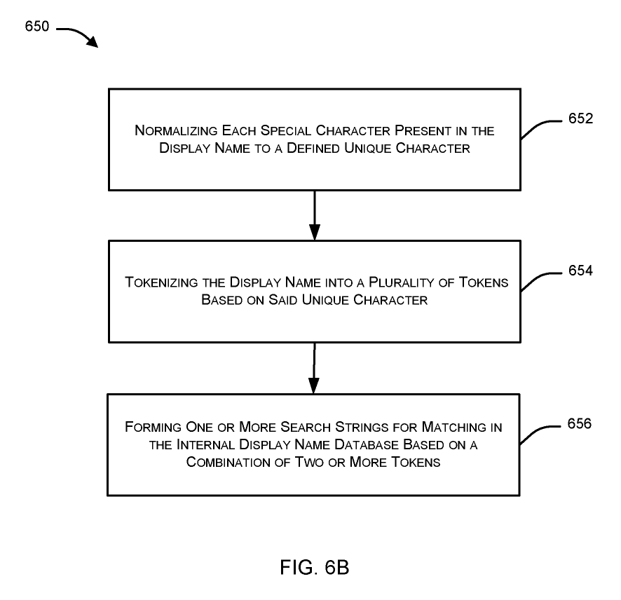

In an embodiment, to perform string matching (e.g., between an extracted display name or an extracted domain and a set of internal display names or the protected domain, respectively) each special character present in the display name can be normalized to a defined unique character, such as a whitespace character (e.g., a character tabulation, a line feed, a line tabulation, a form feed, a carriage return, a space, a next line, a no-break space and the like). For example, if the display name of a user is “abc.xyz_enty”, after performing normalization of the special characters of the display name with a space character, the normalized form of display name can be represented as “abc xyz enty”. Further, multiple tokens can be generated by performing tokenization of the normalized form of display name. For example, when tokenization of “abc xyz enty” is performed (recognizing whitespace as a token separator), three tokens can be generated say “abc”, “xyz” and “enty”. After tokenization, two or more tokens can be combined to form various search strings that can be searched in the internal display name database 208. For example, from tokens “abc”, “xyz” and “enty”, various search strings including, but not limited to, “abcxyz”, “abcenty”, “xyzenty” and “abcxyzenty” can be formed. The search strings and the tokens can then be matched against internal display name database 208 to find a match meeting the similarity threshold. If a similar or exact match is found, email 102 can be identified as a spoofed email that involves sender impersonation. An exemplary method of performing matching is explained in further detail below with reference to FIG. 6B.

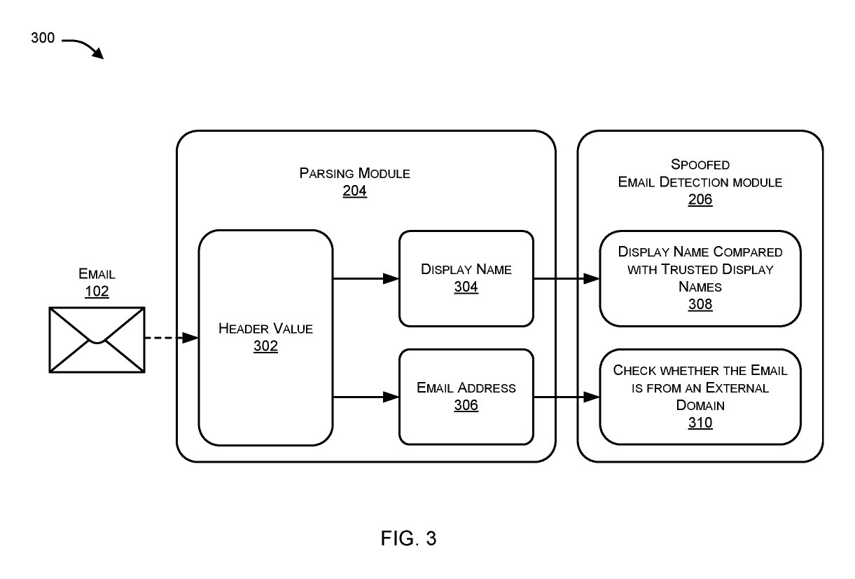

FIG. 3 is a block diagram 300 conceptually illustrating the processing of an email message 102 in accordance with an embodiment of the present invention. In the context of the present example, email 102 is received by parsing module 204 that parses a header value 302 of email 102 into a display name 304 and an email address 306. Spoofed email detection module 206 can then check whether email address 306 is associated with an external domain as block 310, where email 102 is determined to be associated with an external domain when domain 304 is anything other than the domain protected by the network security device implementing parsing module 204 and spoofed email detection module 206.

Responsive to email address 306 being determined to be associated with an external domain, spoofed email detection module 206 compares display name 304 with trusted display names at block 308. Based on the comparison at block 308, when a substantial similarity if found between display name 304 and any trusted display name, email 102 can be identified as potentially involving sender impersonation. The substantial similarity can be determined based on the pre-determined or configurable similarity threshold.

In one embodiment, detection of spoofed emails can be performed on the basis of the header value of the “From” header field contained in email 102. Alternatively, in other embodiments, detection of spoofed emails can be performed on the basis of the header value of other header fields that can identify the origin domain, including, but not limited to “Return-Path” header field, “Received” header field and “Message-Id” header field. The “Return-Path” header field can have a header value indicating the email address of the return email, which can be similar to a “Reply-To” header field indicating details of sender of email 102. In one embodiment, the “Received” header field may be treated as the most reliable as it includes a list of all the servers/computers through which email 102 has traveled in order to be received by the recipient. The “Received” header can be of two parts where one part can indicate the recipient's system or mail server and the other part can indicate the origin of the email or sender's information. The “Message-Id” header field can be a string assigned by the mail system when the email is first created.

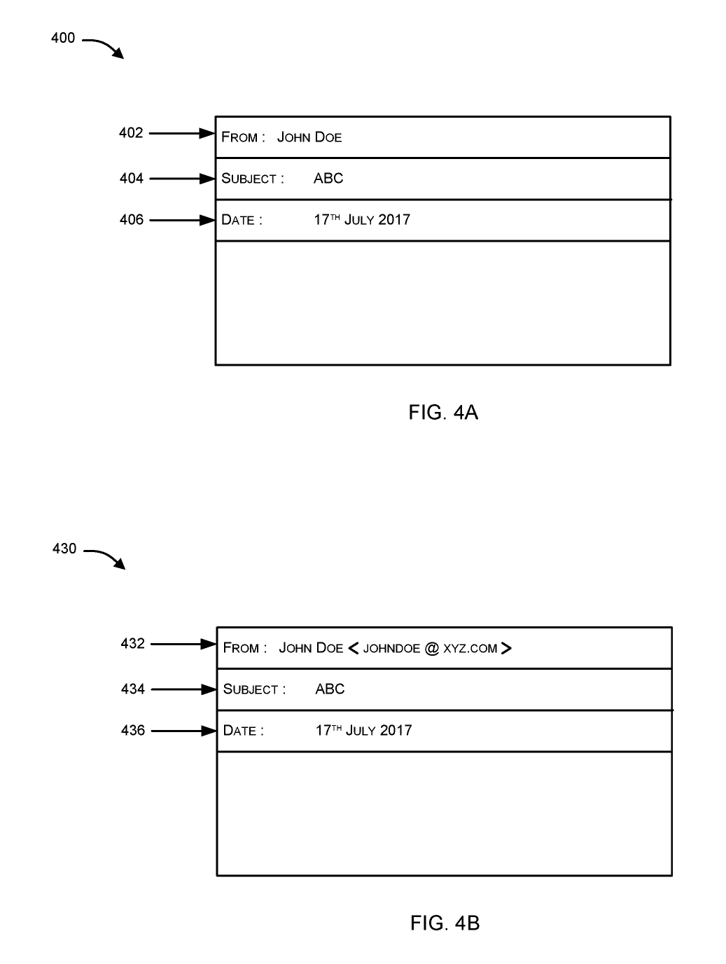

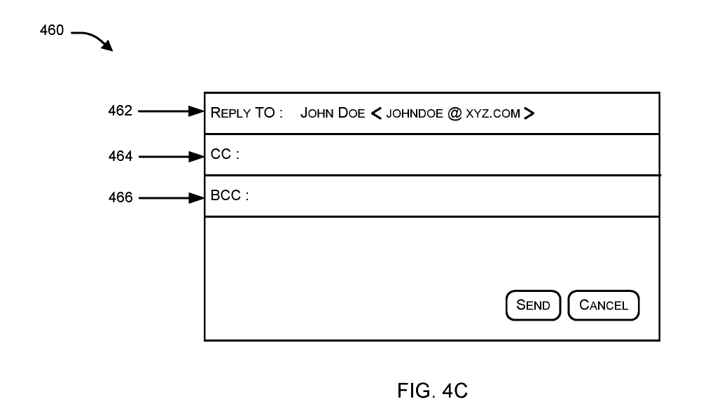

FIGS. 4A-C show various ways email clients may present a received email message to the recipient. Email clients can present a received email to the recipient in various ways as illustrated in FIG. 4A, FIG. 4B and FIG. 4C. In one example, represented by FIG. 4A, a displayed email 400 by an email client can show the sender's information on a “From” line 402, the subject of the email on a subject line 404 and a date of the email on a date line 406. If the email is received from “Mr. John Doe” with email address “johndoe@xyz.com”, depending on the particular implementation of the email client at issue, the “From” line 402 may only contain the display name “John Doe,” despite the actual header value of the “From” header of the received email containing “John Doe <johndoe@xyz.com>”.

In another example, illustrated by FIG. 4B, a displayed email 430 by an email client can show a more complete version of the sender's information in a “From” line 432, including both the display name portion “John Doe” and the email address portion “johndoe@xyz.com” extracted from the “From” header field of the received email message as well as the subject of the email on a subject line 434 and a date of the email on a date line 436.

In yet another example, a displayed email 460 by an email client can show the sender's information extracted from a “Reply-To” header field of the received email message on a Reply To line 462 as well as information extracted from a “CC” header field and a “BCC” header field on a carbon copy line 464 and a blind carbon copy line 466, respectively.

Regardless of the form in which a received email is presented to the recipient by the email client at issue, system 108 extracts the display name and the email address from one or more designated header fields (e.g., the “From” and/or “Reply-To” headers) and processes them accordingly to detect potential email sender impersonation.

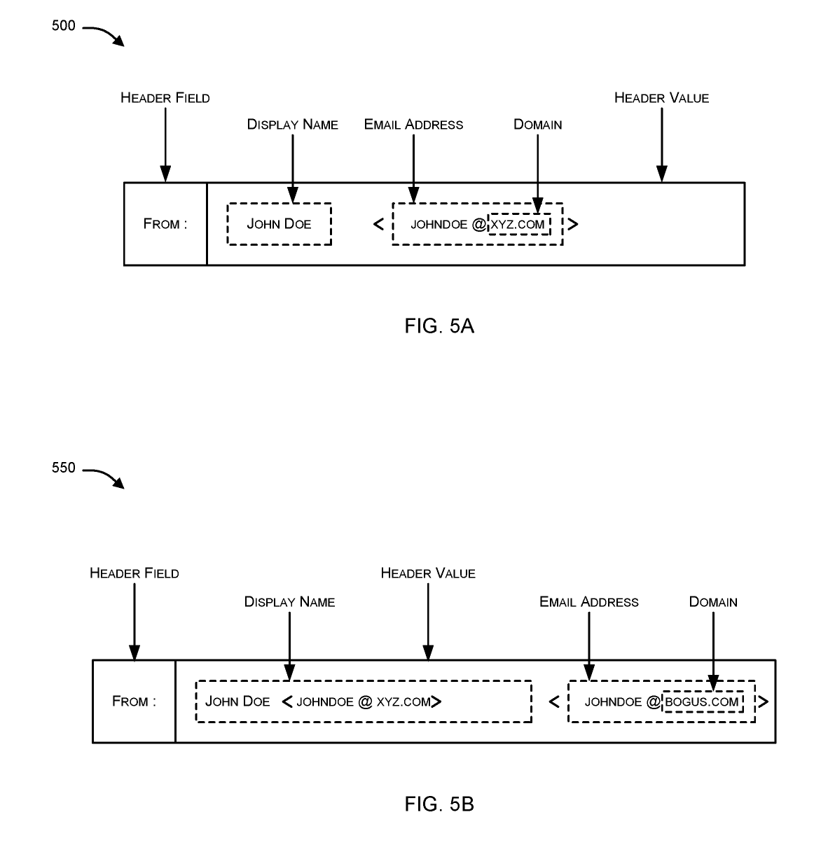

FIGS. 5A-5B depict portions of a “From” header 500 of an email message. As illustrated, in FIG. 5A, “From” header field 500 has a header value “John Doe <johndoe@xyz.com>”, where “John Doe” is the display name and “johndoe@xyz.com” is the email address of the sender associated with the domain “xyz.com”. In FIG. 5B, “From” header field 550 has a header value “John Doe <johndoe@xyz.com> <johndoe@bogus.com>”, where “John Doe <johndoe@xyz.com>” is the display name, and “johndoe@bogus.com” is the email address of the sender. Thus, when only the display name is visible to the recipient and the email address is hidden, the recipient can be given the false impression that the email was received from “johndoe@xyz.com”, when the email was actually received from “johndoe@bogus.com”. Having been duped by the partial display of information by the email client, the recipient may become a victim of an impersonation attack. Thus, to alert or notify the recipient or block such emails, for example, embodiments of the present disclosure can be utilized to analyze the actual email address “johndoe@bogus.com,” the associated domain “bogus.com,” and the display name “John Doe <johndoe@xyz.com>” to identify potential email sender impersonation.

FIG. 6A is a flow diagram 600 illustrating email sender impersonation detection processing in accordance with an embodiment of the present invention.

Flow diagram 600 illustrates a method for protecting a private network by facilitating detection of a spoofed email. The method may be performed, for example, by a secure email gateway protecting a private network. In an aspect, at step 602, the secure email gateway receives an email that is directed to a user of the private network and can perform parsing of a value of a header field of the email, for example, the “From” header field, in order to extract a display name and an email address.

In an aspect, at step 602, it can be determined whether the email address extracted from the received email is associated with an external domain. For example, when the domain of the extracted email address does not match the domain protected by the secure email gateway the received email is determined to associated with an external domain.

In an aspect, at step 606, responsive to determining the received email is from with an external domain, a comparison of the extracted display name with display names associated with users of the private network can be performed to check whether the comparison meets a predetermined or configurable similarity threshold. When the comparison meets the predetermined or configurable similarity threshold, then the received email can be identified as potentially involving sender impersonation. According to one embodiment, this comparison is performed as described below with reference to FIG. 6B.

FIG. 6B is a flow diagram 650 illustrating display name match processing in accordance with an embodiment of the present invention. In the context of the present example, at step 652, each special character of the extracted display name can be normalized to a defined unique character.

At step 654, the display name can be tokenized into multiple tokens based on the unique character. For example, the unique character can be considered as a delimiter to perform tokenization.

At step 656, one or more search strings can be formed based on a combination of two or more tokens. The search strings and the tokens can then be utilized for performing approximate string matching against display names in the internal display name database. If a match is found having substantial similarity, that is a resemblance meeting the predefined or configurable similarity threshold, the email is identified as potentially involving sender impersonation.

For purposes of illustration, an exemplary spoofed email detection process in accordance with an embodiment of the present invention is now explained by way of an example. Assume a received email includes a “From” header field having a header value “John Doe <johndoe@xyz.com> <johndoe@bogus.com>.” First, the header value can be parsed to identify “John Doe <johndoe@xyz.com>” as the display name and “johndoe@bogus.com” as the email address. Then, it can be determined that the email address is associated with an external domain as email is received from the domain “bogus.com,” which is not the domain being protected by the secure email gateway. Responsive to this determination, the extracted display name from the header value can be utilized for detection of a spoofed email. Each special character of the display name can be normalized to a unique character such as a whitespace character, a period, or the like. In this example, a period is used for purposes of performing normalization. Thus, removing whitespace and special characters from the display name and replacing them with periods results in the display name “John Doe <johndoe@xyz.com>” being represented as “John.Doe.johndoe.xyz.com.” Considering the chosen unique character (i.e., the period in this example) as a delimiter, the display name can now be tokenized into multiple tokens such as “John”, “Doe”, “johndoe”, “xyz”, and “com”. Further, multiple search strings can be formed by combining multiple of the various resulting tokens. Example search strings include, but are not limited to, “Johndoe”, “johnxyz”, and “johndoexyz”. Such search strings and tokens can then be utilized to perform approximate string matching against display names within an internal display name database containing display names of users associated with the private network. If a match is found having a degree of similarity satisfying a predetermined or configurable similarity threshold, then the received email is identified as potentially involving sender impersonation.

Embodiments of the present disclosure include various steps, which have been described above. A variety of these steps may be performed by hardware components or may be tangibly embodied on a computer-readable storage medium in the form of machine-executable instructions, which may be used to cause a general-purpose or special-purpose processor programmed with instructions to perform these steps. Alternatively, the steps may be performed by a combination of hardware, software, and/or firmware.

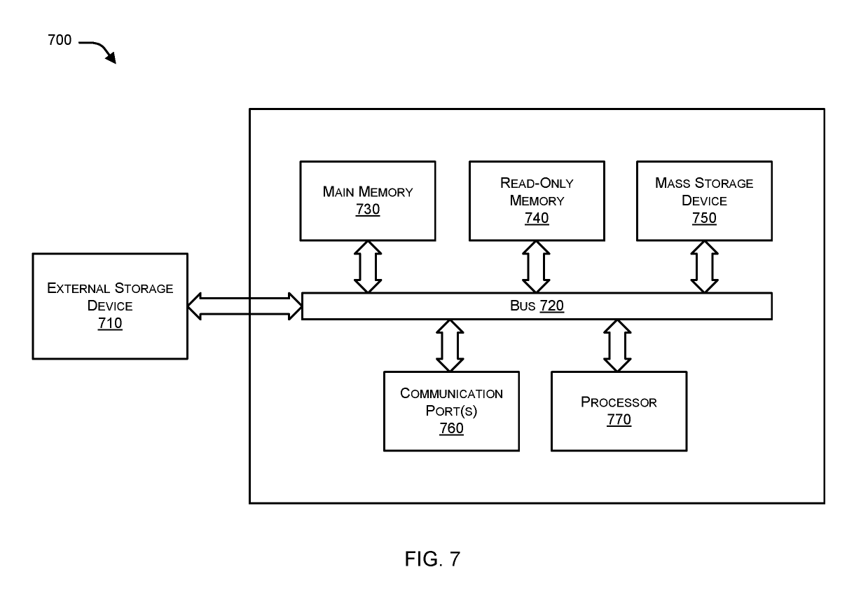

FIG. 7 illustrates an exemplary computer system 700 in which or with which embodiments of the present invention may be utilized in accordance with embodiments of the present disclosure. Computer system 700 may represent a network security device (e.g., network security device 106 or a secure email gateway) that protects a private network against email sender impersonation.

As shown in FIG. 7, computer system 700 includes an external storage device 710, a bus 720, a main memory 730, a read only memory 740, a mass storage device 750, communication port 760, and a processor 770.

A person skilled in the art will appreciate that computer system may include more than one processor and communication ports. Examples of processor 770 include, but are not limited to, an Intel® Itanium® or Itanium 2 processor(s), or AMD® Opteron® or Athlon MP® processor(s), Motorola® lines of processors, FortiSOC™ system on a chip processors or other future processors. Processor 770 may include various modules associated with embodiments of the present invention. Communication port 760 can be any of an RS-232 port for use with a modem based dialup connection, a 10/100 Ethernet port, a Gigabit or 10 Gigabit port using copper or fiber, a serial port, a parallel port, or other existing or future ports. Communication port 760 may be chosen depending on a network, such a Local Area Network (LAN), Wide Area Network (WAN), or any network to which computer system connects.

Memory 730 can be Random Access Memory (RAM), or any other dynamic storage device commonly known in the art. Read only memory 740 can be any static storage device(s) e.g., but not limited to, a Programmable Read Only Memory (PROM) chips for storing static information e.g., start-up or BIOS instructions for processor 770. Mass storage 750 may be any current or future mass storage solution, which can be used to store information and/or instructions. Exemplary mass storage solutions include, but are not limited to, Parallel Advanced Technology Attachment (PATA) or Serial Advanced Technology Attachment (SATA) hard disk drives or solid-state drives (internal or external, e.g., having Universal Serial Bus (USB) and/or Firewire interfaces), e.g. those available from Seagate (e.g., the Seagate Barracuda 7200 family) or Hitachi (e.g., the Hitachi Deskstar 7K1000), one or more optical discs, Redundant Array of Independent Disks (RAID) storage, e.g. an array of disks (e.g., SATA arrays), available from various vendors including Dot Hill Systems Corp., LaCie, Nexsan Technologies, Inc. and Enhance Technology, Inc.

Bus 720 communicatively couples processor(s) 770 with the other memory, storage and communication blocks. Bus 720 can be, e.g. a Peripheral Component Interconnect (PCI)/PCI Extended (PCI-X) bus, Small Computer System Interface (SCSI), USB or the like, for connecting expansion cards, drives and other subsystems as well as other buses, such a front side bus (FSB), which connects processor 770 to software system.

Optionally, operator and administrative interfaces, e.g. a display, keyboard, and a cursor control device, may also be coupled to bus 720 to support direct operator interaction with computer system. Other operator and administrative interfaces can be provided through network connections connected through communication port 760. External storage device 710 can be any kind of external hard-drives, floppy drives, IOMEGA® Zip Drives, Compact Disc-Read Only Memory (CD-ROM), Compact Disc-Re-Writable (CD-RW), Digital Video Disk-Read Only Memory (DVD-ROM). Components described above are meant only to exemplify various possibilities. In no way should the aforementioned exemplary computer system limit the scope of the present disclosure.

Thus, it will be appreciated by those of ordinary skill in the art that the diagrams, schematics, illustrations, and the like represent conceptual views or processes illustrating systems and methods embodying this invention. The functions of the various elements shown in the figures may be provided through the use of dedicated hardware as well as hardware capable of executing associated software. Similarly, any switches shown in the figures are conceptual only. Their function may be carried out through the operation of program logic, through dedicated logic, through the interaction of program control and dedicated logic, or even manually, the particular technique being selectable by the entity implementing this invention. Those of ordinary skill in the art further understand that the exemplary hardware, software, processes, methods, and/or operating systems described herein are for illustrative purposes and, thus, are not intended to be limited to any particular named.

As used herein, and unless the context dictates otherwise, the term “coupled to” is intended to include both direct coupling (in which two elements that are coupled to each other contact each other)and indirect coupling (in which at least one additional element is located between the two elements). Therefore, the terms “coupled to” and “coupled with” are used synonymously. Within the context of this document terms “coupled to” and “coupled with” are also used euphemistically to mean “communicatively coupled with” over a network, where two or more devices are able to exchange data with each other over the network, possibly via one or more intermediary device.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

While the foregoing describes various embodiments of the invention, other and further embodiments of the invention may be devised without departing from the basic scope thereof. The scope of the invention is determined by the claims that follow. The invention is not limited to the described embodiments, versions or examples, which are included to enable a person having ordinary skill in the art to make and use the invention when combined with information and knowledge available to the person having ordinary skill in the art.

What is claimed is:

1. A secure email gateway for protecting a private network, the secure email gateway comprising:
a non-transitory storage device having embodied therein one or more routines operable to facilitate detection of a spoofed email; and
one or more processors coupled to the non-transitory storage device and operable to execute the one or more routines, wherein the one or more routines include:
a parsing module, which when executed by the one or more processors, parses a value of at least one header field of a received email into a display name and an email address; and
a spoofed email detection module, which when executed by the one or more processors, determines whether the received email address is associated with an external domain and if so, identifies the received email as potentially involving sender impersonation when a comparison of the display name with a plurality of display names associated with users of the private network meets a predetermined or configurable similarity threshold.

2. The secure email gateway of claim 1, wherein the at least one header field is selected from any or a combination of “From”, “Reply-To”, “Reply to All”, “CC”, and “BCC”.

3. The secure email gateway of claim 1, wherein the domain associated with the email address is considered an external domain when said domain does not match a domain protected by the secure email gateway.

4. The secure email gateway of claim 1, wherein said comparison of the display name with the plurality of display names associated with users of the private network is performed by matching the display name against an internal display name database.

5. The secure email gateway of claim 4, wherein the internal display name database is generated based on any or a combination of processing of inbound email traffic, outbound email traffic, and a query or an import from one or more email directory servers associated with the private network.

6. The secure email gateway of claim 4, wherein the email is determined to be spoofed when the display name is found to be present in the internal display name database.

7. The secure email gateway of claim 4, wherein said matching of the display name against the internal display name database is carried out after normalization of each special character present in the display name to a defined unique character, and tokenization of the display name into a plurality of tokens using the unique character as a delimiter to form one or more search strings based on a combination of two or more of the plurality of tokens and wherein the one or more search strings are used to perform approximate string matching against display names contained in the internal display name database.

8. The secure email gateway of claim 7, wherein the unique character comprises a whitespace character.

9. A method comprising:
receiving, by a network security device protecting a private network, an email;
parsing, by the network security device, a value of at least one header field of the received email into a display name and an email address;
determining whether the received email is associated with an external domain; and
when said determining is affirmative, then identifying whether the received email potentially involves sender impersonation when a comparison of the display name with a plurality of display names associated with users of the private network meets a predetermined or configurable similarity threshold.

10. The method of claim 9, wherein the at least one header field is selected from any or a combination of “From”, “Reply-To”, “Reply to All”, “CC”, and “BCC”.

11. The method of claim 9, wherein the received email is determined to be associated with an external domain when a domain of the email address does not match a domain protected by the network security device.

12. The method of claim 9, wherein said comparison of the display name with the plurality of display names associated with users of the private network is performed by matching the display name against an internal display name database.

13. The method of claim 12, wherein the internal display name database is generated from any or a combination of processing of inbound email traffic, outbound email traffic, and query or import from one or more email directory servers.

14. The method of claim 12, wherein the email is determined to be spoofed when the display name is found to be present in the internal display name database.

15. The method of claim 12, wherein said matching of the display name in the internal display name database is preceded by:
normalizing each special character present in the display name to a defined unique character;
tokenizing the display name into a plurality of tokens using the unique character as a delimiter;
forming one or more search strings based on a combination of two or more of the plurality tokens; and
wherein the one or more search strings are used to perform approximate string matching against display names contained in the internal display name database.

16. The method of claim 16, wherein the unique character comprises a whitespace character.
